(19) United States
(12) Patent Application Publication
(10) Pub. No.: US 2024/0134530 A1
(43) Pub. Date: Apr. 25, 2024

(54) AVOIDING RAID ARRAY OVERDRIVE USING NONVOLATILE MEMORY IN CACHE

(71) Applicant: International Business Machines Corporation, Armonk, NY (US)

(72) Inventors: Hui Zhang, Shanghai (CN); Gang Lyu, Shanghai (CN)

(21) Appl. No.: 17/971,109

(22) Filed: Oct. 20, 2022

(51) Int. Cl. G06F 3/06

(52) U.S. Cl. CPC G06F 3/0611; G06F 3/0659; G06F 3/0689

(57) ABSTRACT

In one general embodiment, a computer-implemented method includes detecting overdrive of a RAID array. An extent residing, at least in part, in both the overdriven RAID array and in a cache is selected. Data missing from the extent is staged, from the overdriven RAID array, to complete the extent in the cache. The original extent space in the overdriven RAID array is freed. The extent data in the cache is destaged to a target RAID array. Space in the cache corresponding to the extent is freed in response to completing the destaging.

### BACKGROUND

The present invention relates to data storage, and more specifically, this invention relates to avoiding overdrive in Redundant Array of Independent Disks (RAID) and other types of data storage arrays.

A high capacity Solid State Drive (SSD) array can be overdriven by write workload. For instance, high capacity solid state drives tend to have lower I/O bandwidth and throughput per unit of capacity relative to higher performance solid state drives. While batch jobs are a normal type of workload running on host servers, a batch job or other application executed on the host server can generate sequential write commands with a heavy workload. High capacity flash drives tend to be overdriven by bursts of the sequential write workload more easily. Accordingly, this causes performance degradation against the host applications or jobs, usually manifested as slower response times.

Other types of data storage drives may also be subject to being overdriven.

Current extent migration is not fast enough to mitigate RAID array overdrive. Currently in storage tiering technology, extent migration is used to mitigate or release the overdrive of RAID arrays. Extent migration for overdrive mitigation typically includes migrating selected extents from an overdriven source RAID array to a target RAID array. However, under the current state of the art design, extent migration does not happen until a next migration cycle. Such delay tends to keep the source RAID array in the overdrive state for a long time.

Moreover, in the current state of the art, extent migration stages all the data of the extent from the source RAID array to memory and then destages the data to the target RAID array. This causes heavy extra stage workloads to the source RAID array. By this design of staging the full extent from the RAID array, many write intercepts may occur.

What is needed is a prompt and agile response to RAID array overdrive.

### SUMMARY

A computer-implemented method, in accordance with one embodiment, includes detecting overdrive of a RAID array. An extent residing, at least in part, in both the overdriven RAID array and in a cache is selected. Data missing from the extent is staged, from the overdriven RAID array, to complete the extent in the cache. The original extent space in the overdriven RAID array is freed. The extent data in the cache is destaged to a target RAID array. Space in the cache corresponding to the extent is freed in response to completing the destaging.

A computer program product, in accordance with one embodiment, includes one or more computer readable storage media, and program instructions collectively stored on the one or more computer readable storage media. The program instructions include program instructions to perform the foregoing method.

A system, in accordance with one embodiment, includes a processor and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a diagram of a tiered data storage system, in accordance with one embodiment of the present invention.

FIG. 3 is a flowchart of a method, in accordance with one embodiment of the present invention.

FIG. 4 depicts a system, in accordance with one embodiment of the present invention.

FIG. 5 is a flowchart of a method, in accordance with one embodiment of the present invention.

FIG. 6 is a flowchart of a method, in accordance with one embodiment of the present invention.

FIG. 7 is a flowchart of a method, in accordance with one embodiment of the present invention.

FIG. 8 is a flowchart of a method, in accordance with one embodiment of the present invention.

FIG. 9 is a flowchart of a method, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for avoiding overdrive in a RAID array by using nonvolatile memory. It should be appreciated that various embodiments herein can be implemented with a wide range of memory mediums, including for example non-volatile random access memory (NVRAM) technologies such as NAND Flash memory, NOR Flash memory, phase-change memory (PCM), magnetoresistive RAM (MRAM) and resistive RAM (RRAM). To provide a context, and solely to assist the reader, various embodiments may be described with reference to a type of non-volatile memory. This has been done by way of example only, and should not be deemed limiting on the invention defined in the claims.

In one general embodiment, a computer-implemented method includes detecting overdrive of a RAID array. An extent residing, at least in part, in both the overdriven RAID array and in a cache is selected. Data missing from the extent is staged, from the overdriven RAID array, to complete the extent in the cache. The original extent space in the overdriven RAID array is freed. The extent data in the cache is destaged to a target RAID array. Space in the cache corresponding to the extent is freed in response to completing the destaging.

In another general embodiment, a computer program product includes one or more computer readable storage media, and program instructions collectively stored on the one or more computer readable storage media. The program instructions include program instructions to perform the foregoing method.

In another general embodiment, a system includes a processor and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as overdrive mitigation code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

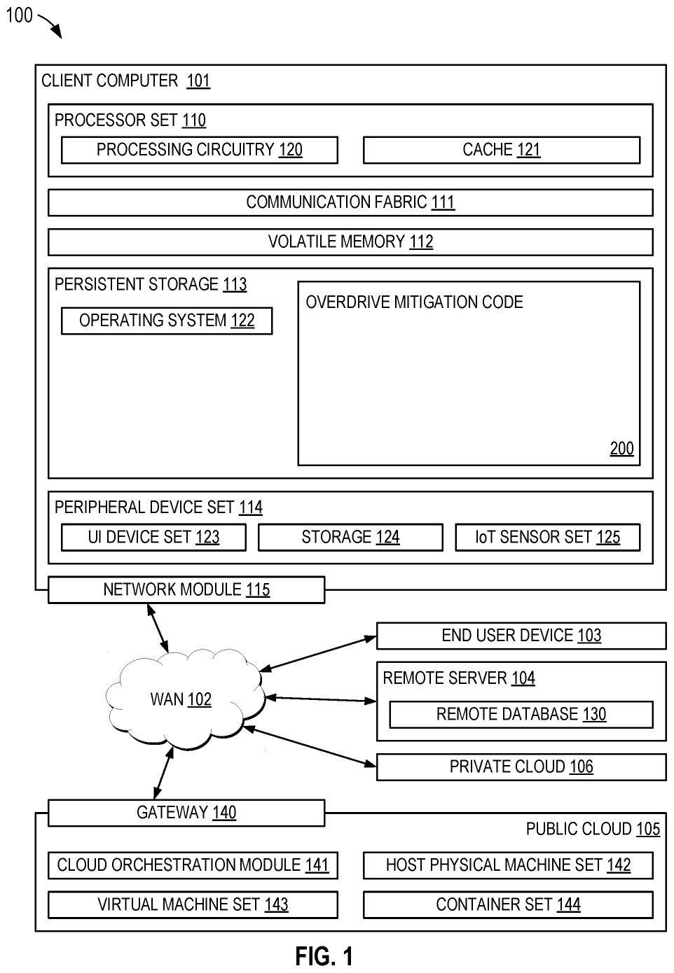

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

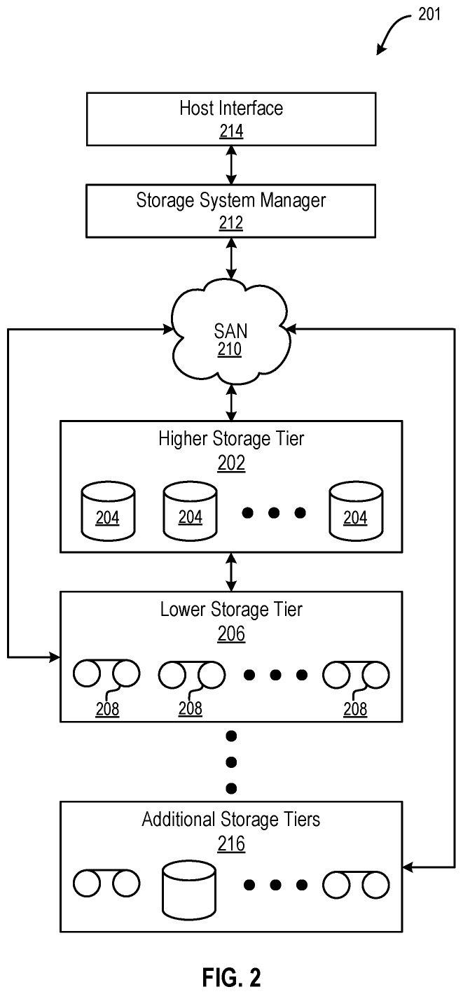

Now referring to FIG. 2, a storage system 201 is shown according to one embodiment. Note that some of the elements shown in FIG. 2 may be implemented as hardware and/or software, according to various embodiments. The storage system 201 may include a storage system manager 212 for communicating with a plurality of media and/or drives on at least one higher storage tier 202 and at least one lower storage tier 206. The higher storage tier(s) 202 preferably may include one or more random access and/or direct access media 204, such as hard disks in hard disk drives (HDDs), nonvolatile memory (NVM), solid state memory in solid state drives (SSDs), flash memory, SSD arrays, flash memory arrays, etc., and/or others noted herein or known in the art. The lower storage tier(s) 206 may preferably include one or more lower performing storage media 208, including sequential access media such as magnetic tape in tape drives and/or optical media, slower accessing HDDs, slower accessing SSDs, etc., and/or others noted herein or known in the art. One or more additional storage tiers 216 may include any combination of storage memory media as desired by a designer of the system 201. Also, any of the higher storage tiers 202 and/or the lower storage tiers 206 may include some combination of storage devices and/or storage media.

The storage system manager 212 may communicate with the drives and/or storage media 204, 208 on the higher storage tier(s) 202 and lower storage tier(s) 206 through a network 210, such as a storage area network (SAN), as shown in FIG. 2, or some other suitable network type. The storage system manager 212 may also communicate with one or more host systems (not shown) through a host interface 214, which may or may not be a part of the storage system manager 212. The storage system manager 212 and/or any other component of the storage system 201 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more embodiments, the storage system 201 may include any number of data storage tiers, and may include the same or different storage memory media within each storage tier. For example, each data storage tier may include the same type of storage memory media, such as HDDs, SSDs, sequential access media (tape in tape drives, optical disc in optical disc drives, etc.), direct access media (CD-ROM, DVD-ROM, etc.), or any combination of media storage types. In one such configuration, a higher storage tier 202, may include a majority of SSD storage media for storing data in a higher performing storage environment, and remaining storage tiers, including lower storage tier 206 and additional storage tiers 216 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 202, while data not having one of these attributes may be stored to the additional storage tiers 216, including lower storage tier 206. Of course, one of skill in the art, upon reading the present descriptions, may devise many other combinations of storage media types to implement into different storage schemes, according to the embodiments presented herein.

According to some embodiments, the storage system (such as 201) may include logic configured to receive a request to open a data set, logic configured to determine if the requested data set is stored to a lower storage tier 206 of a tiered data storage system 201 in multiple associated portions, logic configured to move each associated portion of the requested data set to a higher storage tier 202 of the tiered data storage system 201, and logic configured to assemble the requested data set on the higher storage tier 202 of the tiered data storage system 201 from the associated portions.

Of course, this logic may be implemented as a method on any device and/or system or as a computer program product, according to various embodiments.

Various embodiments of the present invention leverage Non-Volatile Memory (NVM) such as NVRAM, persistent memory, or Storage Class Memory (SCM) to mitigate RAID array overdrive and migration issue by constructing a full extent in memory and immediately selecting a new target to offload the data to. The methodology presented herein is especially useful for RAID arrays composed of high capacity solid state drives. Moreover, these types of NVM may provide performance close to that of SDRAM, and in many cases can be used as the main memory of the system to protect the data against the loss of system power.

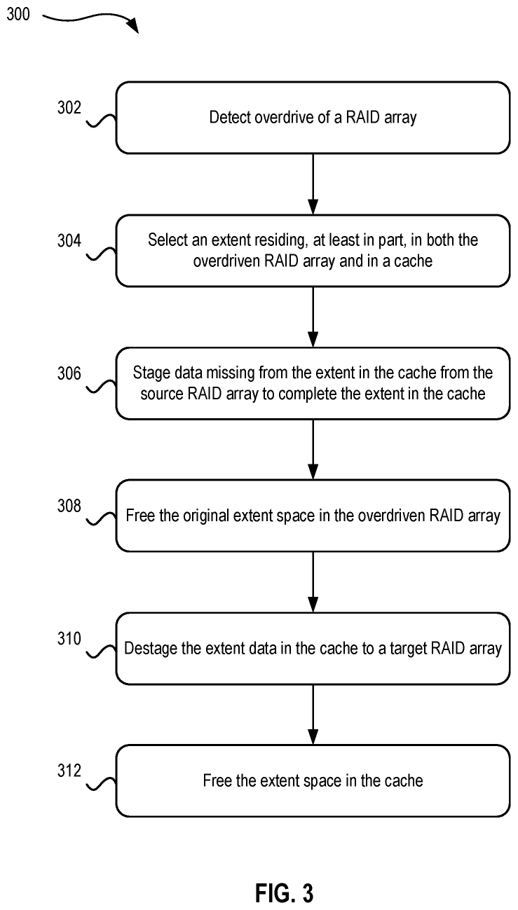

Now referring to FIG. 3, a flowchart of a method 300 is shown according to one embodiment. The method 300 may be performed in accordance with the present invention in any of the environments depicted in FIGS. 1-2, among others, in various embodiments. Of course, more or fewer operations than those specifically described in FIG. 3 may be included in method 300, as would be understood by one of skill in the art upon reading the present descriptions.

Each of the steps of the method 300 may be performed by any suitable component of the operating environment. For example, in various embodiments, the method 300 may be partially or entirely performed by a storage controller, or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 3, method 300 may initiate with operation 302, where overdrive of a RAID array of any type or composition is detected. In one general approach, the overdrive of a RAID array is detected in a prompt way by using a performance counter with a suitable sampling frequency. The RAID array being overdriven is referred to herein, equivalently, as the source array, source RAID array, overdriven array, and overdriven RAID array.

An illustrative subprocess for detection of RAID array overdrive by write workloads includes predefining one or more write-rate based thresholds, such as the threshold of maximum write response time/latency, threshold of maximum throughput/bandwidth, threshold of maximum RAID array utilization, etc., for every RAID array according to the type and parameters of the drives therein. The performance indicators for each RAID array are monitored. In a preferred embodiment, the performance counter with high sampling frequency in the driver is used as the performance indicator. In one approach, the average values of performance indicators of the write workload are calculated at fixed interval, such as every 5 seconds, every 15 seconds, etc. If one, all, or some predefined combination of the performance indicators exceed the corresponding threshold(s), the corresponding RAID array is flagged as being in overdrive. Extent migration is preferably triggered immediately.

In operation 304, an extent residing, at least in part, in both the overdriven RAID array and in a cache is selected.

The full extent to be migrated is constructed in cache, and only data missing from the extent is staged from the source RAID array to build the complete extent in cache. Accordingly, in operation 306, data missing from the extent in the cache is staged from the source RAID array to complete the extent in the cache. Staging only missing data from the source RAID array reduces the extra stage workload to the source RAID array during the migration process.

Preferably, write intercept to the corresponding data is also launched. During write intercept, when staging the extents from the source RAID array to the cache, if new write commands to the extents come, they are held in the cache without destaging to the source RAID array until the extent is mapped to the new target RAID array. Then the new write commands overwrite the data at the same addresses staged from the source RAID array.

Staging only missing data from the source RAID array reduces the amount of write intercept. For example, this also avoids the subsequent repeated migration effort if releasing writes to the source array during migration.

The priority of migration, as it pertains to which overdriven RAID arrays to service first, as well as which extents to migrate, is set according to any suitable factors. In one approach, priority of migration is set according to the severity of overdrive or heat of the extents and RAID arrays. In another approach, the priority of migration is set according to the ratio of the amount of the buffered data in cache to the amount of missing data in the source RAID array to minimize the extra data to be staged.

In operation 308, the original extent space in the overdriven RAID array is freed. This operation may be performed after the data is staged to the cache, in response to completing the destaging, etc.

In operation 310, the extent data in the cache is destaged to a target RAID array.

For sequential write commands, the extents are preferably destaged from cache into the available target RAID array immediately. Destaging to the target RAID array and staging from the source RAID array preferably occur in parallel.

For random write commands, if the cache has enough available free space, the extents stay in NVM (cache, tier 0) for a longer period, and are later destaged into the available target RAID arrays, e.g., when the cache is overdriven, or the extents become colder. For example, the entire extent is stored in non-volatile memory (cache) as storage layer tier 0 (primary location for serving read/write requests for data in the extent for the lowest read/write response time), and the volume mapping table directly points to the extent in the non-volatile memory to improve the cache hit rate. Moreover, the storage space on the source array where the portion of the extent migrated to cache resided is released to reduce the occupation and workload of the storage space. Once the cache is overloaded or the extent becomes cold, the space is allocated on the target array and the extent is offloaded to the target array. The volume mapping table is made to point to the extent on the target array to free cache space.

In a preferred embodiment, the volume mapping table is used for address translation between addresses (e.g., logical block addresses (LBAs)) of the volume and addresses (e.g., LBAs) of the RAID array. The volume mapping table is also used to record the addresses of extents in cache and in RAID arrays.

As alluded to above, the extent space in the cache is freed in response to completing the destaging. See operation 312.

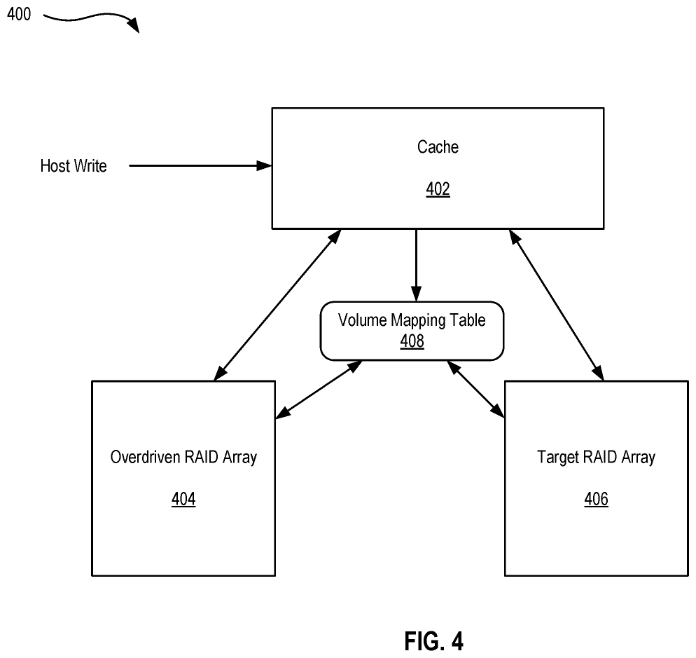

Exemplary embodiments for several general scenarios are presented below by way of example only. FIG. 4 depicts a system 400 usable in each of the various scenarios. As an option, the present system 400 may be implemented in conjunction with features from any other embodiment listed herein, such as those described with reference to the other FIGS. Of course, however, such system 400 and others presented herein may be used in various applications and/or in permutations which may or may not be specifically described in the illustrative embodiments listed herein. Further, the system 400 presented herein may be used in any desired environment.

As shown, host writes to an extent are applied to a cache 402. Writes to the cache are destaged into the source RAID array 404. When the source RAID array 404 becomes overdriven, a target RAID array 406 is selected and used, e.g., according to the scenarios below. A volume mapping table 408 is used for address translation between LBAs of the volume and the LBAs of the RAID array. The volume mapping table is also used to record the addresses of extents in cache and in RAID arrays.

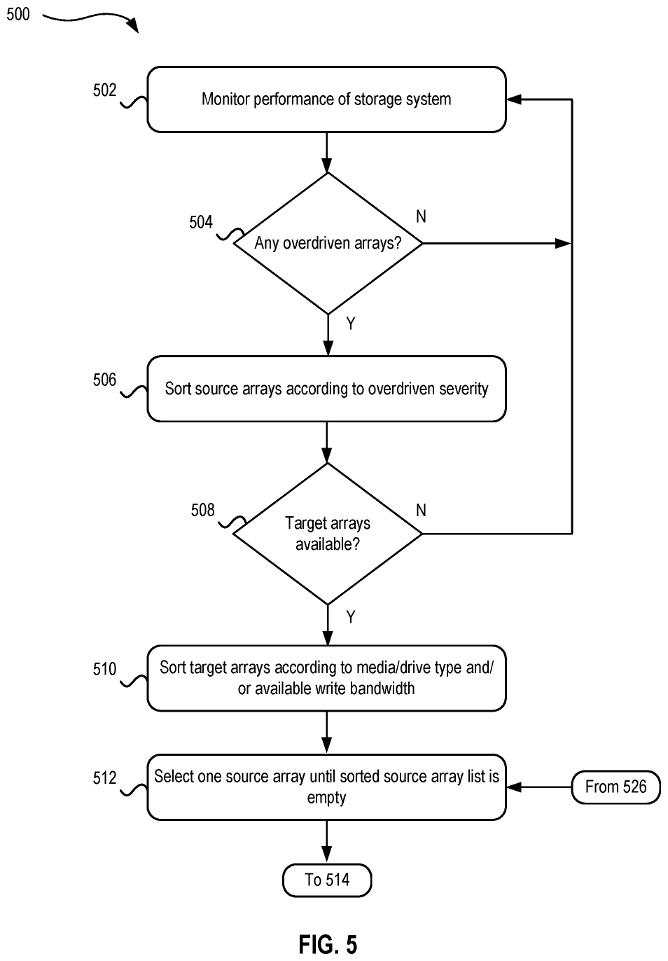

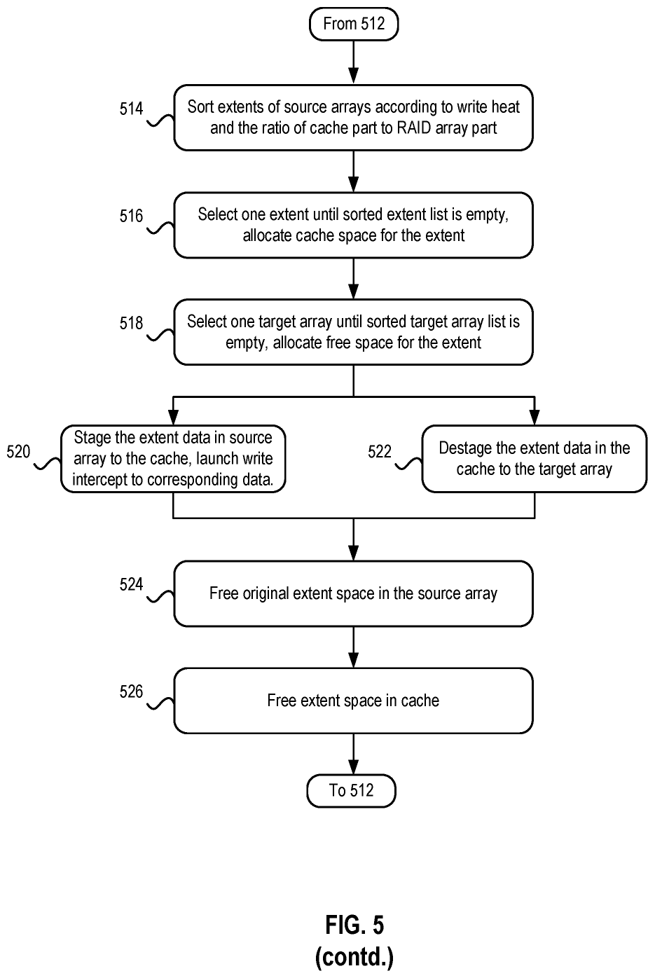

Now referring to FIG. 5, a flowchart of an illustrative method 500 is shown according to one embodiment. The method 500 is particularly useful when sequential write commands overdrive one or more RAID arrays.

The method 500 may be performed in accordance with the present invention in any of the environments depicted in FIGS. 1-3, among others, in various embodiments. Of course, more or fewer operations than those specifically described in FIG. 5 may be included in method 500, as would be understood by one of skill in the art upon reading the present descriptions.

Each of the steps of the method 500 may be performed by any suitable component of the operating environment. For example, in various embodiments, the method 500 may be partially or entirely performed by a storage controller, or some other device having one or more processors therein. The processor, e.g., processing circuit(s), chip(s), and/or module(s) implemented in hardware and/or software, and preferably having at least one hardware component may be utilized in any device to perform one or more steps of the method 500. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 5, method 500 may initiate with operation 502, where performance of a storage system is monitored. Parameters may be defined for such monitoring. In one approach, parameters such as the Throughput_Threshold_High and Throughput_Threshold_Low of every RAID array predefined according to their corresponding bandwidth. Throughput_Threshold_High is used to determine if the RAID array is in an overdriven state, while Throughput_Threshold_Low is used to determine if the RAID array is an available array. As will soon become apparent, an extent of an overdriven (source) RAID array is migrated to an available (target) RAID array. For the same RAID array, Throughput_Threshold_High is larger than Throughput_Threshold_Low. Other performance indicators can also be used.

In operation 504, an overflow write throughput is calculated, e.g., by subtracting the Throughput_Threshold_High from the actual throughput of write commands for every RAID array. A determination is made as to whether overflow write throughput of at least one RAID array is positive. That is, check whether at least one RAID array is overdriven. If so, the process continues on. Extent migration of the sequential write commands is set to higher priority than that of the random write commands for a specific RAID array.

In operation 506, each source RAID array is sorted according to the ratio of its actual throughput of write commands to its Throughput_Threshold_High and/or according to overflow write throughput. The extent migration is launched according to the sorted RAID array list. Extent migration from different source RAID arrays and from different extents within a source RAID array can be launched in parallel.

In operation 508, the available write bandwidth is calculated by subtracting the actual throughput of write commands from the Throughput_Threshold_Low for every RAID array. A determination is made as to whether available write bandwidth of at least one RAID array is positive. That is, check whether at least one RAID array is available to work as the migration target. If so, the process continues.

In operation 510, the target RAID arrays are sorted according to the type of the storage media or drive, such as Phase Change memory, high performance flash drive, high capacity flash drive, mechanical drive with different revolutions per minute (RPMs), etc. In one approach, the target RAID arrays are sorted according to the respective ratio of its Throughput_Threshold_Low to its actual throughput of write commands and/or according to available write bandwidth. Extent migration to different target RAID arrays and to different extents within a target RAID array may be launched in parallel.

In operation 512, a source RAID array is selected from the sorted list.

In operation 514, the extents of the source RAID array are grouped into different buckets (e.g., heat grades) according to the write throughput and/or write heat. The buckets are sorted accordingly. The data of an extent resides in the RAID array and may also be buffered in the cache (NVM) for the latest version. Thus, every extent of the source RAID array may be composed of two parts: a cache part and a RAID array part (not in cache). The size of the cache part and RAID array part is determined for every extent. Extents in the same bucket are sorted according to the ratio of cache part to RAID array part.

In operation 516, one extent is selected from the sorted list. If needed, more space in the cache (e.g., NVM) is allocated to the extent. The entry of the extent is updated in the volume mapping table. The source RAID pointer points to the extent address in the source RAID array. The cache pointer points to the extent address in the cache.

In operation 518, one target RAID array is selected from the sorted list. Free space is allocated for the extent. The entry of the extent is updated in the volume mapping table. The target RAID pointer points to the extent address of the target RAID array.

In operation 520, the RAID array part of the extent is staged from the source RAID array to the cache. New write commands to the data which have not been staged to the cache are held in the cache without destaging to the source RAID array (write intercept). When old data at the same address has been staged from the source RAID array to the cache, it is overwritten by the new write commands. If the data have been stored in the cache, write intercept is released.

Preferably in parallel with operation 520, operation 522 destages the data in the cache into the target RAID array. New write commands may be destaged into the target RAID array according to the cache algorithm, in the usual manner (with no write intercept). The data is preferably still maintained in cache even when it has been destaged into the target RAID array.

When the whole RAID array part of the extent has been staged into the cache, the original space of the extent in the source RAID array is freed. See operation 524. The corresponding pointers in the volume mapping table are deleted.

In operation 526, some or all of the extent space in the cache may be freed. For example, when the full extent has been destaged into the target RAID array, the extent data in the cache can be removed or managed in the usual manner by the cache algorithm. The corresponding pointers of the entry of the extent in the volume mapping table are also deleted.

The process may return to operation 512 for selection of the next extent, the next source RAID array and the next target RAID array from the corresponding sorted list recursively. In preferred approaches, extent migrations can be handled in parallel.

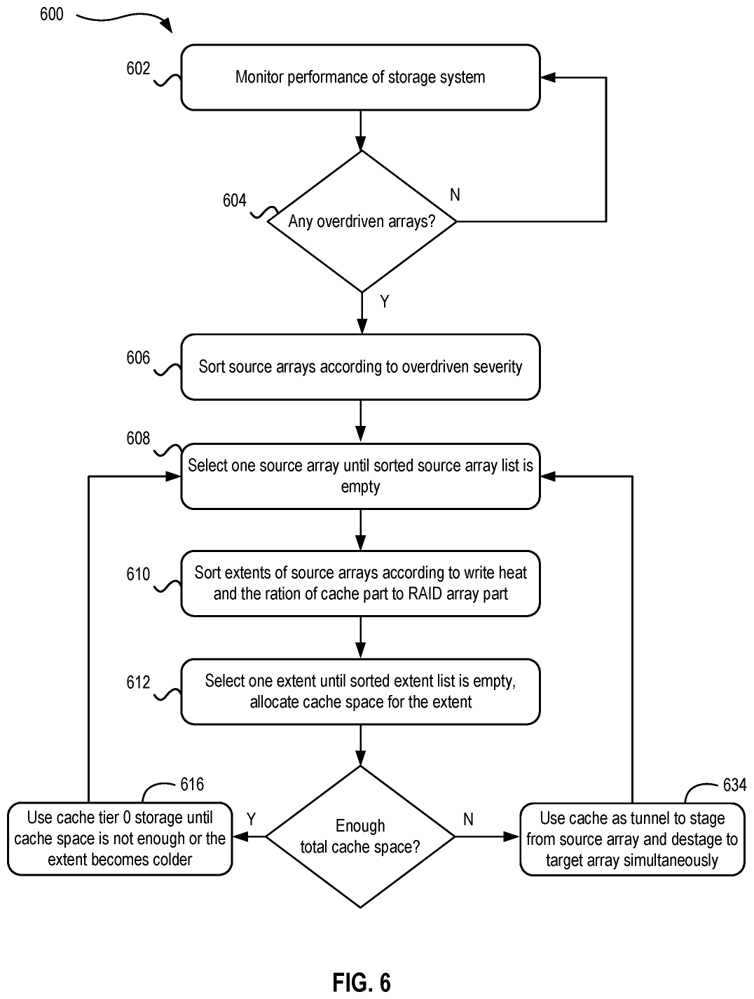

Now referring to FIG. 6, a flowchart of a method 600 is shown according to one embodiment. The method 600 is particularly useful when random write commands overdrive one or more RAID arrays.

The method 600 may be performed in accordance with the present invention in any of the environments depicted in FIGS. 1-5, among others, in various embodiments. Of course, more or fewer operations than those specifically described in FIG. 6 may be included in method 600, as would be understood by one of skill in the art upon reading the present descriptions.

Each of the steps of the method 600 may be performed by any suitable component of the operating environment. For example, in various embodiments, the method 600 may be partially or entirely performed by a storage controller, or some other device having one or more processors therein. The processor, e.g., processing circuit(s), chip(s), and/or module(s) implemented in hardware and/or software, and preferably having at least one hardware component may be utilized in any device to perform one or more steps of the method 600. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 6, method 600 may initiate with operation 602, where performance of a storage system is monitored. Parameters may be defined for such monitoring. In one approach, parameters such as the Throughput_Threshold_High and Throughput_Threshold_Low of every RAID array predefined according to their corresponding bandwidth. Throughput_Threshold_High is used to determine if the RAID array is in an overdriven state, while Throughput_Threshold_Low is used to determine if the RAID array is an available array. The Available_Cache_Space_Threshold is predefined as the threshold to determine whether to allocate the cache space as tier 0 for the extent. For the same RAID array, Throughput_Threshold_High is larger than Throughput_Threshold_Low. Other performance indicators can also be used.

In operation 604, the overflow write rate is calculated by subtracting the Write_Rate_Threshold_High from the actual I/O rate of write commands for every RAID array. A determination is made as to whether the overflow write rate of at least one RAID array is positive. That is, a check is made as to whether at least one RAID array is overdriven. If so, the process continues. Extent migration of the sequential write commands is set to a higher priority than that of the random write commands for a specific RAID array.

In operation 606, the source RAID arrays are sorted according to the respective ratio of the actual I/O rate of write commands to the Write_Rate_Threshold_High and/or according to overflow write rate for that RAID array. The extent migration is launched according to the sorted RAID array list. Extent migration from different source RAID arrays and from different extents within a source RAID array may be launched in parallel.

In operation 608, one source RAID array is selected from the sorted list.

In operation 610, the extents of the source RAID array are grouped into different buckets (e.g., heat grades) according to the write rate and/or write heat. The buckets are sorted accordingly. The data of an extent resides in the RAID array and may also be buffered in the cache for the latest version. Thus, every extent of the source RAID array may be composed of two parts: cache part and RAID array part (not in cache). The sizes of the cache part and the RAID array part are detected for every extent. The extents in the same bucket are sorted according to the ratio of cache part to RAID array part.

In operation 612, an extent is selected from the sorted list.

If needed, more space in cache (NVM) is allocated to the extent in operation 614. The entry of the extent is updated in the volume mapping table. The source RAID pointer points to the extent address in the source RAID array. The cache pointer points to the extent address in the cache.

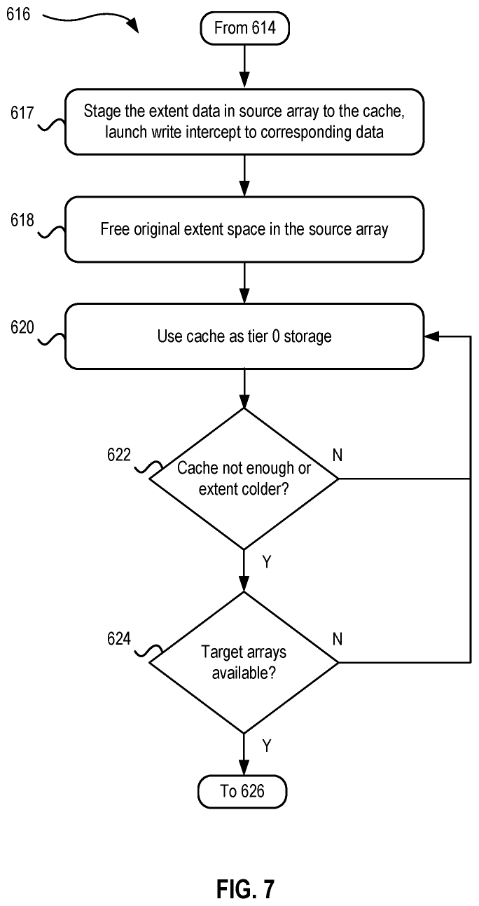

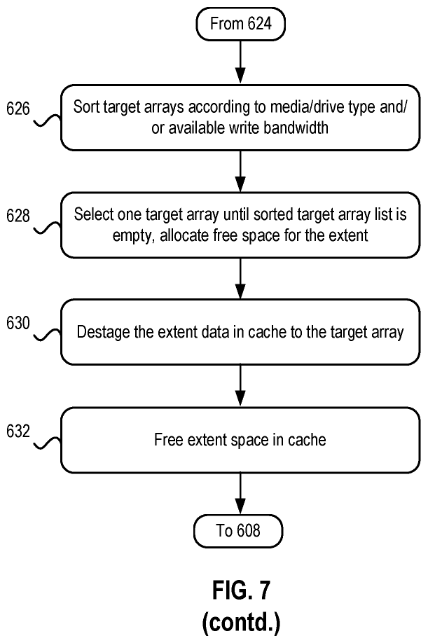

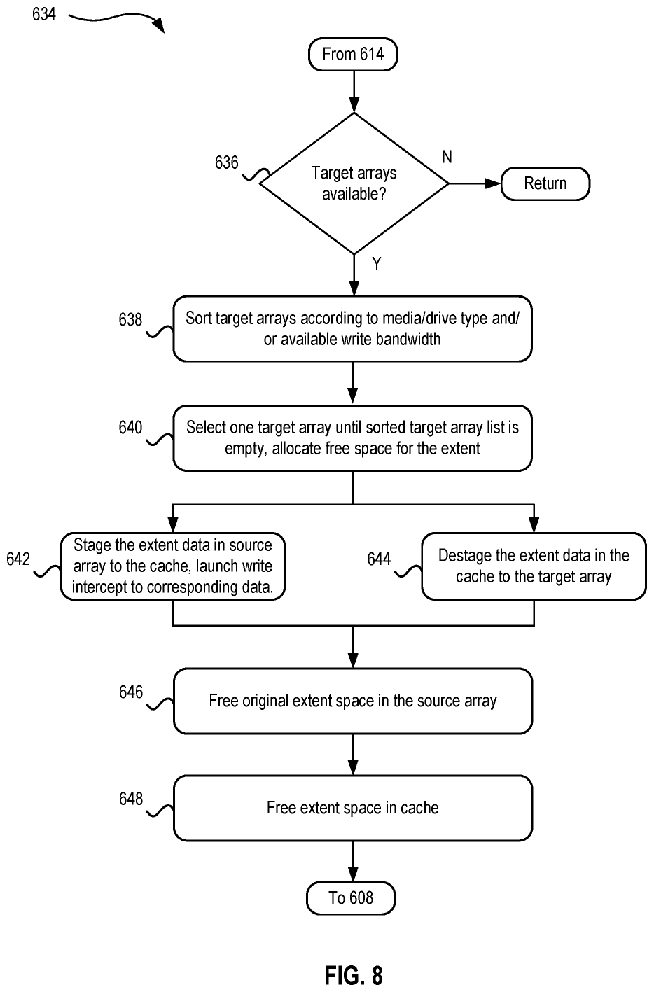

In a preferred approach, the available free space of the cache is determined. If the available free space of the cache is larger than the Available_Cache_Space_Threshold, the process proceeds to operation 616 (see FIG. 7). If the available free space of the cache is less than or equal to Available_Cache_Space_Threshold, the process proceeds to operation 634 (see FIG. 8) where, in response to determining that the cache does not have sufficient space for the extent, the cache is used as a tunnel to stage the missing data from the overdriven RAID array to the cache and destage the data to the target RAID array simultaneously. Preferably, the NVM, Persistent Memory, or Storage Class Memory (SCM) is used as the cache for the extent migration.

FIG. 7 depicts a sub-process of operation 616. In operation 617, the RAID array part of the extent from the source RAID array is staged to the cache. During the period of staging, new write commands to the data which have not been staged to the cache are held in the cache without destaging to the source RAID array (write intercept). When old data at the same address has been staged from the source RAID array to the cache, it is overwritten by the new write commands.

When the whole RAID array part of the extent has been staged into the cache, the original space of the extent in the source RAID array is freed. See operation 618. The corresponding pointers in the volume mapping table are deleted.

As shown in operation 620, the cache (NVM memory) acts as tier 0 storage and the extent can reside in cache for a long time. The new write commands to the extent only update the corresponding data in NVM memory.

At decision 622, if the available free space of the cache is less than or equal to Available_Cache_Space_Threshold or the extent becomes colder, the process proceeds to decision 624.

At decision 624, a determination is made as to whether any target RAID arrays are available. In one approach, the available write bandwidth is calculated by subtracting the actual I/O rate of write commands from the Write_Rate_Threshold_Low for every RAID array. A determination is made as to whether the available write bandwidth of at least one RAID array is positive. That is, a check is made as to whether at least one RAID array is available to work as the migration target. If so, the process continues.

In operation 626, the target RAID arrays are sorted according to the type of the storage media and/or drive, such as Phase Change memory, high performance flash drive, high capacity flash drive, mechanical drives with different RPMs, etc. The target RAID arrays are sorted according to their respective ratio of Write_Rate_Threshold_Low to its actual I/O rate of write commands and/or according to available write bandwidth. Extent migration to different target RAID arrays and to different extents within a target RAID array can be launched in parallel.

In operation 628, a target RAID array is selected from the sorted list. Free space for the extent is allocated in the target RAID array. The entry of the extent in the volume mapping table is updated. The source pointer points to the extent address of the cache. The target RAID pointer points to the extent address of the target RAID array.

In operation 630, the extent from the cache (NVM memory) is destaged to the target RAID array, e.g., by flush command (e.g., cache commit scan).

In operation 632, in response to the full extent being destaged into the target RAID array, the extent data in the cache can be removed to free space in cache and/or managed by the cache algorithm in a normal manner. The corresponding pointers of the entry of the extent in the volume mapping table are deleted when the flush completes.

Referring again to operation 614 of FIG. 6, if the available free space of the cache is less than or equal to Available_Cache_Space_Threshold, the process proceeds to operation 634. FIG. 8 depicts a sub-process of operation 634.

In operation 636 of FIG. 8, a determination is made as to whether any target RAID arrays are available. In one approach, the available write bandwidth is calculated by subtracting the actual I/O rate of write commands from the Write_Rate_Threshold_Low for every RAID array. A determination is made as to whether the available write bandwidth of at least one RAID array is positive. That is, a determination is made as to whether at least one RAID array is available to work as the migration target. If so, continue the process. If not, the process returns to operation 608 of FIG. 6.

In operation 638, the target RAID arrays are sorted according to the type of the storage media and/or drive type, such as Phase Change memory, high performance flash drive, high capacity flash drive, mechanical drive with different RPMs, etc. The target RAID arrays are sorted according to the respective ratio of their Throughput_Threshold_Low to their actual throughput of write commands and/or according to available write bandwidth. Extent migration to different target RAID arrays and to different extents within a target RAID array can be launched in parallel.

In operation 640, a target RAID array is selected from the sorted list. Allocate free space for the extent. Update the entry of the extent in the volume mapping table. The target RAID pointer points to the extent address of the target RAID array.

In operation 642, the RAID array part of the extent is staged from the source RAID array to the cache. New write commands to the data which have not been staged to the cache are held in the cache without destaging to the source RAID array (write intercept). When old data at the same address has been staged from the source RAID array to the cache, it is overwritten by the new write commands. If the data has been stored in the cache, write intercept is released.

Preferably at the same time, in parallel, the data in the cache is being destaged into the target RAID array. See operation 644. New write commands may be destaged into the target RAID array according to cache algorithm normally (no write intercept). The data is still maintained in cache even when it has been destaged into the target RAID array.

In operation 646, when the whole RAID array part of the extent has been staged into the cache, the original space of the extent in the source RAID array is freed. The corresponding pointers in the volume mapping table are deleted.

When the full extent has been destaged into the target RAID array, the extent data in the cache may be removed to fee space in the cache, or is managed by the cache algorithm normally. The corresponding pointers of the entry of the extent in the volume mapping table are also deleted. See operation 648.

Returning to FIG. 6, after performance of operation 616 or operation 634, the process returns to operation 608 and selection is made of the next extent, the next source RAID array and the next target RAID array from the corresponding sorted list recursively. Extent migration can be handled in parallel.

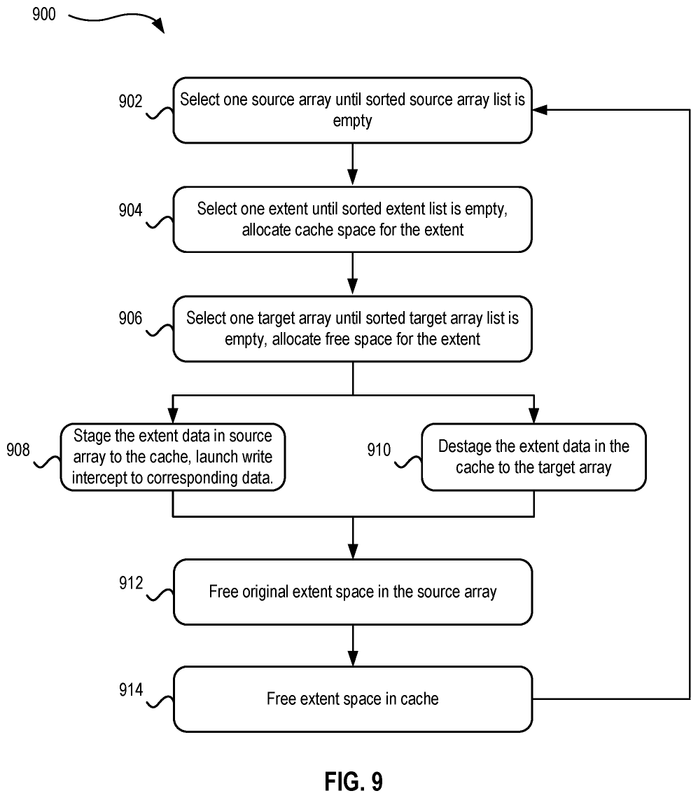

Now referring to FIG. 9, a flowchart of a method 900 is shown according to one embodiment. The method 900 is particularly useful when storage tiering technology triggers extent migration.

The method 900 may be performed in accordance with the present invention in any of the environments depicted in FIGS. 1-8, among others, in various embodiments. Of course, more or fewer operations than those specifically described in FIG. 9 may be included in method 900, as would be understood by one of skill in the art upon reading the present descriptions.

Each of the steps of the method 900 may be performed by any suitable component of the operating environment. For example, in various embodiments, the method 900 may be partially or entirely performed by a storage controller, or some other device having one or more processors therein. The processor, e.g., processing circuit(s), chip(s), and/or module(s) implemented in hardware and/or software, and preferably having at least one hardware component may be utilized in any device to perform one or more steps of the method 900. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 9, method 900 may initiate with operation 902, where storage tiering technology selects the migration source RAID array, e.g., according to a conventional policy and method for selecting a migration source.

In operation 904, storage tiering technology selects the extent to be migrated from the source RAID array. If needed, more space in cache (NVM) is allocated to the extent. The entry of the extent in the volume mapping table is updated. The source RAID pointer points to the extent address in the source RAID array. The cache pointer points to the extent address in the cache.

In operation 906, storage tiering technology selects the migration target RAID array by its policy and method. Free space for the extent is allocated in the target RAID array. The entry of the extent in the volume mapping table is updated. The target RAID pointer points to the extent address of the target RAID array.

In operation 908, the RAID array part of the extent is staged from the source RAID array to the cache. New write commands to the data which have not been staged to the cache are held in the cache without destaging to the source RAID array (write intercept). When old data at the same address has been staged from the source RAID array to the cache, it is overwritten by the new write commands. If the data has been stored in the cache, write intercept is released.

Preferably at the same time (in parallel), the data in the cache is being destaged into the target RAID array. See operation 910. New write commands can be destaged into the target RAID array according to the cache algorithm in a normal manner (no write intercept). The data is still maintained in cache even when it has been destaged into the target RAID array.

In operation 912, when the whole RAID array part of the extent has been staged into the cache, the original space of the extent in the source RAID array is freed. And the corresponding pointers in the volume mapping table is deleted.

In operation 914, when the full extent has been destaged into the target RAID array, the extent data in the cache can be removed or managed by cache algorithm normally. The corresponding pointers of the entry of the extent in the volume mapping table are also deleted.

The process returns to operation 902, where storage tiering technology selects the next extent, the next source RAID array and the next target RAID array by its policy and method recursively. Extent migration can be handled in parallel.

Various embodiments have been disclosed herein, including the general methodology of FIG. 3, the illustrative system of FIG. 4, and the exemplary scenario-based methodologies described with reference to FIGS. 5-9. Advantages of the various methodologies presented herein are many. For example, one advantage is that the extent migration is expedited by taking a prompt migration action and also by staging from a source RAID array and destaging to a target RAID array simultaneously. Another advantage is that good performance for random I/O is ensured by taking NVM in the cache as tier 0 for the hot extent for random writes. Yet another advantage is that the extra stage workload to the source RAID array is reduced by only staging the missing data from the source RAID array to cache, thereby improving operation of the overall system. In addition, the amount of host overwrite commands to be intercepted is reduced by reducing the time window of the extent migration.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
detecting overdrive of a RAID array;
selecting an extent residing, at least in part, in both the overdriven RAID array and in a cache;
staging, from the overdriven RAID array, data missing from the extent to complete the extent in the cache;
freeing the original extent space in the overdriven RAID array;
destaging the extent data in the cache to a target RAID array; and
freeing space in the cache corresponding to the extent in response to completing the destaging.

2. The computer-implemented method of claim 1, wherein detecting overdrive of the RAID array includes determining whether a write rate of the RAID array is above a write rate-based threshold.

3. The computer-implemented method of claim 1, wherein the staging and the destaging are performed in parallel.

4. The computer-implemented method of claim 1, comprising launching write intercept for the extent.

5. The computer-implemented method of claim 1, comprising determining whether the cache has sufficient space for the extent, and in response to determining that the cache has sufficient space for the extent, using the cache as tier 0 for the extent until cache space is needed and/or the extent is determined to be cold.

6. The computer-implemented method of claim 5, comprising updating a volume mapping table to directly point to the extent in the cache to improve the cache hit rate for the extent.

7. The computer-implemented method of claim 1, comprising determining whether the cache has sufficient space for the extent, and in response to determining that the cache does not have sufficient space for the extent, using the cache as a tunnel to stage the missing data from the overdriven RAID array to the cache and destage the data to the target RAID array simultaneously.

8. A computer program product, the computer program product comprising:
one or more computer readable storage media, and program instructions collectively stored on the one or more computer readable storage media, the program instructions comprising:
program instructions to detect overdrive of a RAID array;
program instructions to select an extent residing, at least in part, in both the overdriven RAID array and in a cache;
program instructions to stage, from the overdriven RAID array, data missing from the extent to complete the extent in the cache;
program instructions to free the original extent space in the overdriven RAID array;
program instructions to destage the extent data in the cache to a target RAID array; and
program instructions to free space in the cache corresponding to the extent in response to completing the destaging.

9. The computer program product of claim 8, wherein detecting overdrive of the RAID array includes determining whether a write rate of the RAID array is above a write rate-based threshold.

10. The computer program product of claim 8, wherein the staging and the destaging are performed in parallel.

11. The computer program product of claim 8, comprising program instructions to launch write intercept for the extent.

12. The computer program product of claim 8, comprising program instructions to determine whether the cache has sufficient space for the extent, and in response to determining that the cache has sufficient space for the extent, use the cache as tier 0 for the extent until cache space is needed and/or the extent is determined to be cold.

13. The computer program product of claim 12, comprising program instructions to update a volume mapping table to directly point to the extent in the cache to improve the cache hit rate for the extent.

14. The computer program product of claim 8, comprising program instructions to determine whether the cache has sufficient space for the extent, and in response to determining that the cache does not have sufficient space for the extent, using the cache as a tunnel to stage the missing data from the overdriven RAID array to the cache and destage the data to the target RAID array simultaneously.

15. A system, comprising:
a processor; and
logic integrated with the processor, executable by the processor, or integrated with and executable by the processor, the logic being configured to:
detect overdrive of a RAID array;
select an extent residing, at least in part, in both the overdriven RAID array and in a cache;
stage, from the overdriven RAID array, data missing from the extent to complete the extent in the cache;
free the original extent space in the overdriven RAID array;
destage the extent data in the cache to a target RAID array; and
free space in the cache corresponding to the extent in the cache in response to completing the destaging.

16. The system of claim 15, wherein detecting overdrive of the RAID array includes determining whether a write rate of the RAID array is above a write rate-based threshold.

17. The system of claim 15, wherein the staging and the destaging are performed in parallel.

18. The system of claim 15, comprising logic configured to launch write intercept for the extent.

19. The system of claim 15, comprising logic configured to determine whether the cache has sufficient space for the extent, and in response to determining that the cache has sufficient space for the extent, use the cache as tier 0 for the extent until cache space is needed and/or the extent is determined to be cold; and logic configured to update a volume mapping table to directly point to the extent in the cache to improve the cache hit rate for the extent.

20. The system of claim 15, comprising logic configured to determine whether the cache has sufficient space for the extent, and in response to determining that the cache does not have sufficient space for the extent, using the cache as a tunnel to stage the missing data from the overdriven RAID array to the cache and destage the data to the target RAID array simultaneously.
